(19) United States
(12) Patent Application Publication
(10) Pub. No.: US 2013/0094190 A1
(43) Pub. Date: Apr. 18, 2013

(54) Led taper candle and wreath

(71) Applicant: James S. Gerson, Kansas City, MO (US)

(72) Inventor: James S. Gerson, Kansas City, MO (US)

(21) Appl. No.: 13/317,264

(22) Filed: Oct. 13, 2011

(51) Int. Cl. F21V 35/00; F21L 4/00

(52) U.S. Cl. 362/122

(57) ABSTRACT

An LED taper candle, a battery(ies) and a control switch which are electrically connected. A hook or other device for securing the wreath to a plant, memorial or structure is rigidly connected with the wreath, which allows easy installation by attaching the hook or other device to a plant, memorial or structure.

### RELATED APPLICATIONS

The present application is related to U.S. Pat. No. 4,787,017, issued Nov. 22, 1988, by Vrettos, included by reference herein.

The present application is related to U.S. Pat. No. 5,255,170, issued Nov. 19, 1993, by Plamp et al., included by reference herein.

The present application is related to U.S. Pat. No. 5,564,816, issued Oct. 15, 1996, by Arcadia et al., included by reference herein.

The present application is related to U.S. Pat. No. 6,132,054, issued Oct. 17, 2000, by Rogers et al., included by reference herein.

The present application is related to U.S. Pat. No. 6,234,652, issued May 22, 2001, by Tang, included by reference herein.

The present application is related to U.S. Pat. No. 6,364,503, issued Apr. 2, 2002, by Wenzel et al., included by reference herein.

The present application is related to U.S. Pat. No. 7,125,138, issued Oct. 24, 2006, by Reinmann, included by reference herein.

### FIELD OF THE INVENTION

The invention generally relates to decorative lights and, more specifically, to an LED taper candle integrated with a wreath and a hook or other device for securing the wreath to a plant, memorial or structure making the totality suitable for holiday decoration or for placement near and illumination of graveside, roadside or other memorial sites.

### BACKGROUND OF THE INVENTION

Illumination and containment of holiday decorations or decorations for graveside, roadside or other memorial sites and their surrounding areas is often desired by the owner, sponsor, curator, etc. Such illumination is often cost prohibitive. A power source is often not readily available. Solar power may be precluded by shade and cloudy climate at the site. Skills required for installation of complex lighting systems may be cost prohibitive. Sites may also be relatively unsecure, making expensive lighting solutions costly targets for theft or vandalism.

An object of the invention is to provide a lamp as mentioned at the beginning, which is reliable, resistant inmost environments, watertight, and having low production costs.

A special object of the invention is to provide a lamp of this kind which can also be easily installed by attaching the structurally-integrated hook or other device to a plant, memorial or structure.

A further object is to provide a lamp of this kind which can also be easily moved to accommodate changing decorative elements around a holiday display or a memorial.

### SUMMARY OF THE INVENTION

In accordance with the present invention, there is provided an LED taper candle, a battery(ies) and a control switch which are electrically connected. The LED taper candle may be flickering or steady-on. The control switch may or may not be electrically connected to a light sensor and/or a timer, allowing illumination of the LED taper candle during darkness (i.e., diminished external light) or for a set or variable (switch-selected) number of hours after darkness is detected by the light sensor. A hook or other device is rigidly connected with the wreath, which allows easy installation by attaching the hook or other device to a plant, memorial or structure.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front detail view of an LED taper candle and wreath.

For purposes of clarity and brevity, like elements and components will bear the same designations and numbering throughout the FIGURE.

DESCRIPTION OF THE PREFERRED EMBODIMENT

FIG. 1 is a front detail view of an LED taper candle 12 with hook 24 or other device for securing the wreath 20 to a plant, memorial or structure. This invention is comprised of an LED taper candle 12, a battery(ies) 16 and a control switch 22 which are electrically connected. The control switch 22 may or may not be electrically connected to a light sensor and/or a timer, allowing illumination of the LED taper candle 12 during darkness (i.e., diminished external light) or for a set or variable (switch-selected) number of hours after darkness is detected by the light sensor. A hook 24 or other device is rigidly connected with the wreath 20, which allows easy installation by attaching the wreath 20 to a plant, memorial or structure.

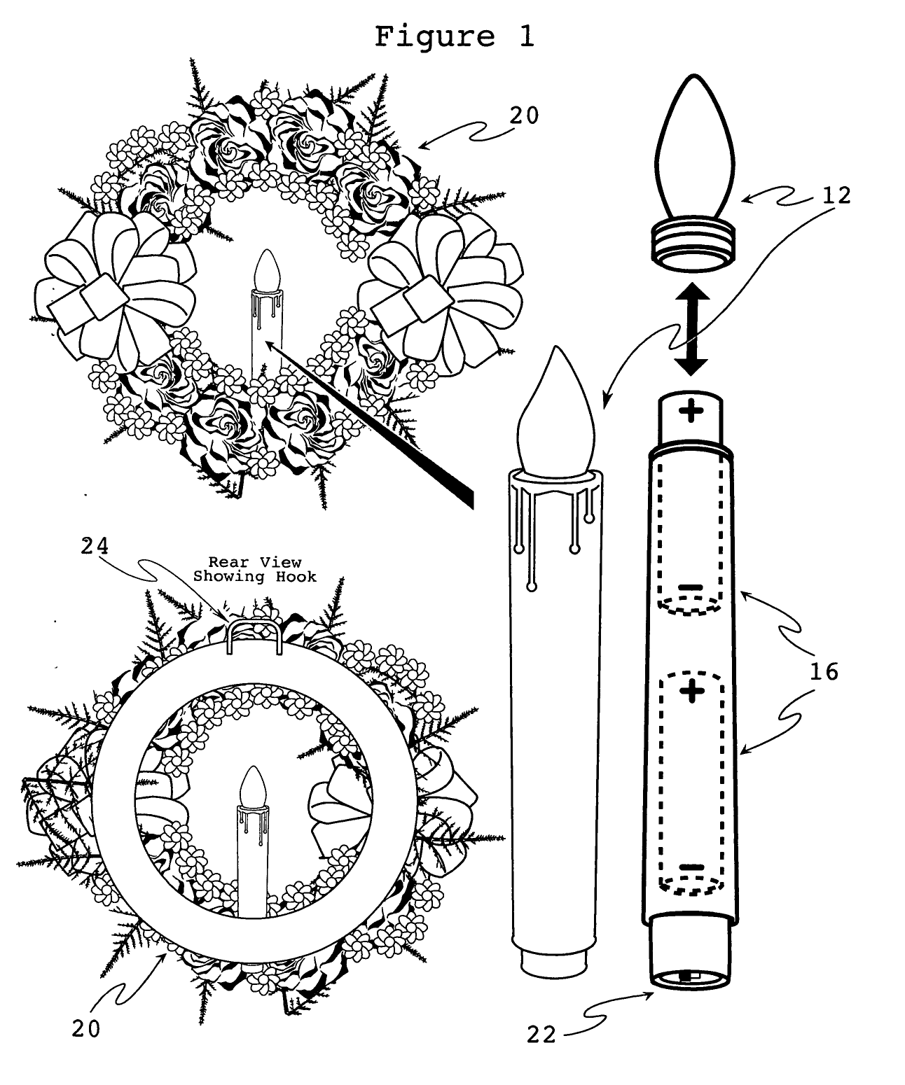

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An LED light suitable for holiday decoration or for placement near and illumination of graveside, roadside or other memorial sites, comprising:
means for an LED taper candle;
means for a wreath, rigidly connected to said means for supporting the LED taper candle;
means for a control switch, electrically connected to said means for controlling power for illumination; and
means for battery(ies), electrically connected to said means for powering illumination;
means for securing a hook or other device for securing the wreath to a plant, memorial or structure, rigidly connected to said means for supporting the LED taper candle.

2. The LED light in accordance with claim 1, wherein said means for supporting the LED taper candle comprises a wreath holding the LED taper candle.

3. The LED light in accordance with claim 1, wherein said means for illumination comprises an LED taper candle.

4. The LED light in accordance with claim 1, wherein said means for controlling power for illumination comprises a control switch.

5. The LED light in accordance with claim 1, wherein said means for powering illumination comprises a battery(ies).

6. The LED light in accordance with claim 1, wherein said means for supporting the LED taper candle comprises a hook or other device for securing the wreath to a plant, memorial or structure.

7. An LED for holiday decoration or for placement near and illumination of graveside, roadside or other memorial sites, comprising:
a wreath for securing the LED taper candle;
an LED taper candle, for illumination, rigidly connected to said wreath;
a control switch, for controlling illumination, electrically connected to said LED taper candle;
a battery(ies), for powering illumination, electrically connected to said control switch, and electrically connected to said LED taper candle; and
a hook or other device for securing the wreath to a plant, memorial or structure, and for securing the LED taper candle, rigidly connected to said wreath.
